(19) United States
(12) Patent Application Publication
(10) Pub. No.: US 2013/0128689 A1
(43) Pub. Date: May 23, 2013

(54) COMMUNICATION DEVICE AND METHOD FOR SENSING AND TRANSMITTING DATA FOR MILITARY SENSORS

(71) Applicant: Lockheed Martin Corporation, Bethesda, MD (US)

(72) Inventors: Anton J. RADMAN, Bristow, VA (US); David C. BOYLE, Alexandria, VA (US); Jack M. GELLEN, Falls Church, VA (US)

(73) Assignee: LOCKHEED MARTIN CORPORATION, Bethesda, MD (US)

(21) Appl. No.: 13/683,631

(22) Filed: Nov. 21, 2012

Related U.S. Application Data
(60) Provisional application No. 61/563,416, filed on Nov. 23, 2011.

(51) Int. Cl. B63B 22/00; H04B 11/00; G01S 15/06; H04B 1/59

(52) U.S. Cl. CPC B63B 22/00; H04B 1/59; H04B 11/00; G01S 15/06
USPC 367/4; 367/131; 367/99

(57) ABSTRACT

A sonobuoy that includes a communications device capable of being communicatively coupled to a computer network. Also disclosed is a network of communications devices placed on sonobuoys. The communications device is capable of several forms of RF transmission. The communications devices are also provided with processors capable of performing signal processing or a portion of signal processing before communicating data to a larger computer for further processing.

### TECHNICAL FIELD

Various embodiments described herein relate to a communication device and method for sensing and transmitting data for a military sensor.

### BACKGROUND

Sonar is a well known apparatus having both civilian and military applications. Sonar (originally an acronym for SOund Navigation And Ranging) is a technique that uses sound propagation, usually underwater, to navigate, communicate with or detect other vessels. Sonar uses sensors placed in arrays to receive sound. The arrays can be deployed in many ways. Some sonar arrays are towed behind a ship or submarine. Another way to deploy an array is by mounting sensors to the hull of a ship, such as a submarine. Still another way is to deploy a sonar system is by way of buoys that have a sonar system within the buoy. The buoys are deployed into the water. The buoys are known as sonobuoys. Sonobuoys can be deployed for many purposes. One purpose is to deploy a single sonobuoy as a marker for a rescue operation. A fixed wing aircraft capable of covering a large area can be used to find a person or vessel in trouble. The fixed wing aircraft deploys the sonobuoy that emits a radio signal. A helicopter or watercraft can now easily locate the person or vessel by homing in on the radio signal. Another purpose includes collecting data for oceanographic research. Still another purpose is a military application to locate an enemy submarine or surface ship.

Sonobuoys used in military air operations are generally expendable. The expendable acoustic listening devices are deployed into seawater to locate submarines by listening to noises generated by the submarines, such as engine and screw noises, and the like. Some sonobuoys also use active “pinging” and listen for an echo, or return, to locate objects. Other sonobuoys are passive and merely listen for noise in the sea. Once dropped by aircraft, sonobuoys provide data which is used by surface ships or airplanes to plot submarine locations in an operating area. Sonobuoys can also locate surface vessels at greater than visual range. Surface ships are able to use the plotted information defensively to position themselves against possible submarine attack, or offensively to attack the submarine. Generally, aircraft fly over an area of a possible submarine location, and then drop sonobuoys into the water. Once in the water, the sonobuoys are activated to listen for submarines, and once a submarine is located, the sonobuoys relay tracking information of the submarine to the surface ship. If the sonobuoys are dropped in a pattern that is large, there are times when an aircraft is so distant from some of the sonobuoys that data from them can not be relayed back to a ship or aircraft until that ship or aircraft gets closer to the sonobuoy. In addition, the military sonobuoys are expendable and so there is a constant goal to build less costly versions. Still another push is that in military operations, the enemy is generally always trying to implement technology that will foil the sonobuoys so that the enemy vessel is not detected. In other words, there is a technology based game of cat and mouse going on. Therefore, there is also a goal of using adaptable technology so that the next technology “move” can be made more easily.

### BRIEF DESCRIPTION OF THE DRAWINGS

FIG. 1 is a side view of a sonobuoy before deployment, according to an example embodiment.

FIG. 2A is a side view of a sonobuoy after partial deployment, according to an example embodiment.

FIG. 2B is a side view of a sonobuoy after deployment, according to an example embodiment.

FIG. 3 is a schematic diagram of a communications device, according to an example embodiment.

FIG. 4 is a schematic diagram of the plurality of sonobuoys including communications devices linked in a network configuration, according to an example embodiment.

FIG. 5 shows a diagrammatic representation of a computer system, within which a set of instructions for causing the machine to perform any one or more of the phase correction methodologies discussed herein can be executed or is adapted to include the apparatus for phase correction, according to an example embodiment.

FIG. 6 is a schematic drawing of a machine readable medium that includes an instruction set, according to an example embodiment.

### DETAILED DESCRIPTION

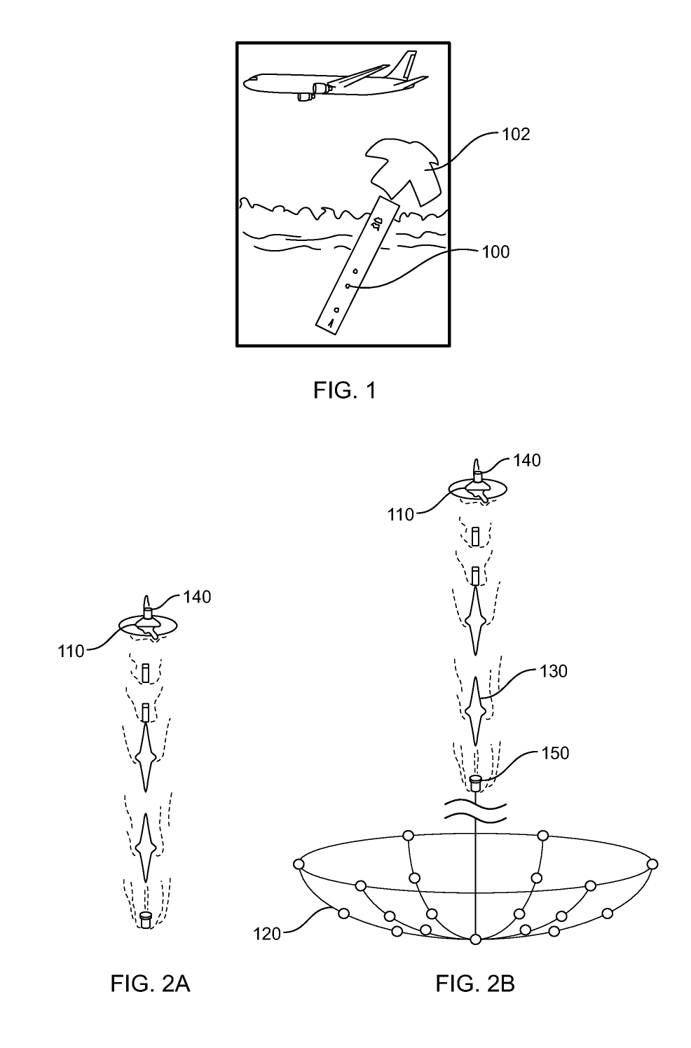

FIG. 1 is a side view of a sonobuoy 100 before deployment in water, according to an example embodiment. FIG. 2A is a side view of a sonobuoy after partial deployment, according to an example embodiment. FIG. 2B is a side view of a sonobuoy after deployment, according to an example embodiment. Now referring to FIGS. 1, 2A and 2B, the sonobuoy 100 will be discussed in more detail. Before deployment, the sonobuoy 100 is substantially cylindrical in shape. The cylinder has a diameter of around 5 inches/13 centimeters, and has a length of about 3 ft/91 cm long. The sonobuoy 100 can be provided with a parachute 102 to slow descent when deployed from an airplane. The sonobuoy 100 can also be deployed by shooting the sonobuoy off the deck of a ship or even by tossing a sonobuoy 100 overboard from a vessel. Within the cylindrical package of the sonobouy 100 is a float 110, a set of one or more hydrophones 120, and an apparatus 130 for placing the set of hydrophones 120 at a certain depth. A line or tether 150 attaches the float 110 to the set of hydrophones 120. The sonobuoy 100 also includes a communications device 140 which is associated with the float 110. The communications device 140 is associated with the float 110 and generally is positioned near the float 110.

The communications device 140 is communicatively coupled to the set of hydrophones 120 via the line or tether 150. In one embodiment, the line or tether 150 includes a wire for electrically coupling the set of hydrophones 120 to the float 110 and the communications device 140. The wire carries signals from the set of hydrophones 120 to the communications device 140. In another embodiment, the set of hydrophones 120 communicate wirelessly to the communications device 140. When fully deployed in the water, the individual hydrophones of the set of hydrophones 120 are spaced from one another.

In one embodiment, when the sonobuoy hits the water the cylindrical package drops away, the float 110 inflates and rises to the top of the water. The set of hydrophones 120 are on a large umbrella-like frame structure that unfolds underwater or unfolds after the sonobuoy 100 hits the water. The umbrella has no cloth and the hydrophones 120 are connected to the frame structure. After the umbrella-like frame unfolds, the set of hydrophones 120 are spaced at essentially known distances from each other and form an array with a known geometry.

The sonobuoy 100 essentially is a sonar system in a relatively small, easily deployable package. The sonobuoy deploys when it hits the water. The relatively small package includes an interface through which certain attributes of the sonobuoy 100 can be selected before deployment. For example, the depth at which the set of hydrophones 120 will be deployed can be selected in one embodiment. There can also be options for the type of communications that will be used by the communications device 140 to relay any information or data detected by the set of hydrophones 120 of the sonobuoy 100.

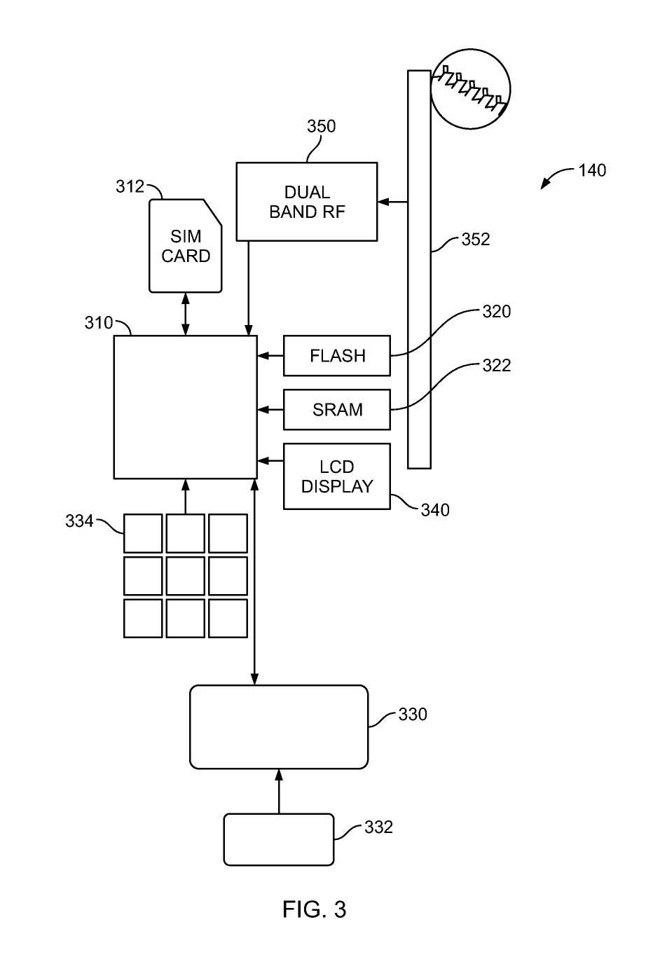

FIG. 3 is a schematic diagram of a communications device, according to an example embodiment. The communications device 140 is ruggedized. Part of the ruggedization includes making the communications device 140 substantially water proof so that water will not disable the communications device 140. The communications device 140 must also be substantially immune to electromagnetic interference/radio frequencly interference (“EMI/RFI”). The communications device 140 includes a microprocessor 310 and memory which includes a flash memory 320 and then SRAM 322. The communications device also includes an LCD display 340. The communications device 140 also includes several input devices, namely, an interface 332 which receives signals from the set of hydrophones 120. The interface 332 and inputs the signals to a analog-to-digital converter 330 before importing them to the microprocessor 310. The communications device 140 also includes an external input device 334, such as a keypad. The keypad or external input device 334 can be used to input selections made for various deployment modes of the sonobuoy 100. The communications device also includes a subscriber identification module (SIM) 312. The SIM 312 is attached to the a microprocessor 310. The SIM 312 is an integrated circuit that securely stores an international mobile subscriber identity and the related key used to identify and authenticate a subscriber on a mobile communication device such as a mobile phone or computer. The microprocessor also has a dual band RF output 350. Attached to the dual band RF output 350 is an antenna 352. The antenna 352 can be an internal antenna or an external antenna. The antenna 352 can be used to communicate with a computer or other communications device aboard an aircraft or a watercraft. In the alternative, the antenna 352 can be used to communicate with similar communications devices 140 deployed near the first communications device 140.

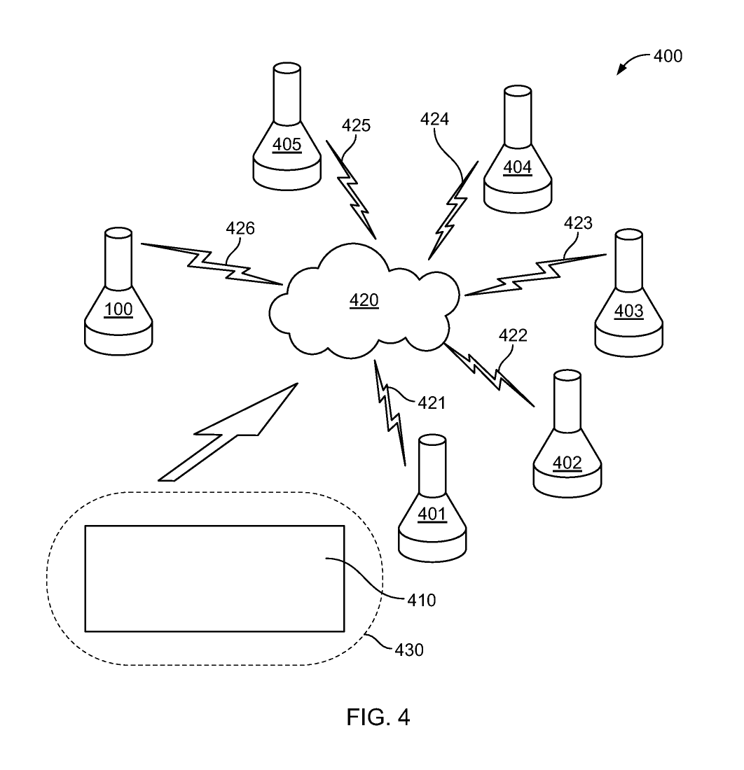

FIG. 4 is a schematic diagram of the plurality of sonobuoys including communications devices 140 linked in a network configuration 400, according to an example embodiment. The plurality of sonobuoys include sonobuoy 100, 401, 402, 403, 404, and 405. Each of the sonobuoys includes a communications device 140. Each communications device is networked together as represented by the cloud 420 in FIG. 4. The sonobuoy 110 is connected to the network 420 as depicted by lightning bolt 426. The connection to the network 420 is wireless. Similarly sonobuoy 401 is connected to the network 420 by lightning bolt 421, sonobuoy 402 is connected to the network by 422, sonobuoy 403 is connected to the network 420 by 423, and sonobuoy 405 is connected to the network 420 by 424. Also connected to the network 420 is a computer 410 that is a board a vessel 430. The vessel 430 can be either a watercraft or an aircraft. The computer 410 is a larger computer used for processing data received from the various sonobuoys connected to the network 420. In one embodiment, data from a distant buoy, such as sonobuoy 404 can be placed onto the network and received by the computer 410 via its network connection. When an array or plurality of sonobuoys includes a distant buoy, there are times when data from the distant buoy cannot be obtained immediately because the communications device associated with sonobuoy 404 must be within range of the communications device associated with the computer 410.

In operation, the sets of hydrophones 120 of each sonobuoy 100, 401, 402, 403, 404, 405 listen for data. The data in a military application can be related to detection of an enemy submarine or surface ship. Data produced by the hydrophones 120 is relayed to the communications device 140 and to the network. The communications device includes an RF transmitter 350 and an antenna 352. The data received by a particular communications device can be communicated to the network 420 which in turn communicates the raw data received to the computer 410 aboard a ship or aircraft 430 where the raw data will be processed. The data received at the computer 410 is processed to determine the location of an enemy vessel, such as a submarine. In addition, the data received can be used to determine the type of submarine or enemy vessel. In another embodiment, the microprocessor 310 which is associated with one of the sonobuoys can be used to determine the location of a submarine or other vessel as well as to determine the type of the vessel. In this particular embodiment the processor 310 for each of the sonobuoys has sufficient processing power to offload or perform operations to process the data at the sonobuoy before sending the information to the network 420.

In one embodiment, the communications device 140 is an ad adapted cell phone. Cell phones operate in a frequency range which is other than the military frequency range. Cell phone could be adapted to operate within a military frequency range. The cell phone could also be ruggedized so that it is waterproof or able to operate in an ocean environment. Cell phone technology has several advantages. One of these advantages is that they use open source software with a set interface definition. The software development kits for cell phones is straightforward and easy to use so that in-buoy software algorithms could be easily developed. This would reduce the cost of development as well as provide for a significant reduction in the cost of the communications device of the sonobuoy. In addition, the communications device would be steadily improved based upon the improvements in cell phone technology and the fast pace at which they occur in today's world. Further advantages include the compact size of cell phones and the emphasis on digitization. In addition, current designs already provide for community or substantial immunity to EMI/RFI. Yet another advantage is the growth potential of the product plus the fact that it is a consumer product that is relatively inexpensive when compared to developing a whole communications device from scratch.

In addition, current programs or software commonly used in cell phones could be leveraged for use in sonobuoys. For example, cell phones include GPS location packages so that such software would not have to be developed if current cell phone technology was used. In addition, cell phones include voice recognition software. The voice recognition software could be enhanced to recognize or identify signatures associated with various vessels, including specific signatures associated with particular vessels. Cell phones also include a multi-band RF capability to allow deployment of sonobuoys for use with Bluetooth, USB, or IR modes. The particular RF mode can be selected prior to deployment through an external interface 334, such as a keypad.

The commercial communications device, such as a cell phone, offers flexibility. For example, arbitrary ping waveforms can be downloaded to a deployed device from an aircraft, ship or other control platform into the buoy. It is contemplated that the sonar buoys could be either active or passive. In an active buoy, the arbitrary pings could then be transmitted acoustically out the transducer, such as the hydrophone. Current active or source buoys have hard coded waveforms due to their limited processing and storage capability. The communications device of the current invention allows the ping waveforms within the buoy to be updated on the fly and test or employ new waveforms and/or processing algorithms. This update capability could also be expanded to the software that runs on the communications device within the buoy. It is contemplated that some of the communications devices will be able to recognize signatures of various crafts and can perform this recognition using the microprocessor of the communications device. Thus, new signatures could also be downloaded to the buoy or, more specifically, to the microprocessor in the communications device within the buoy. Of course, software updates could be made on the fly, regardless of deployment or nondeployment of the buoy.

In another embodiment, CFS/CSG communications could become text message communications. In addition, standard interfaces such as a USB port, mini USB port or micro USB port could be used to interface or connect to the sets of hydrophones 120 associated with a particular sonobuoy.

The communications devices 140 associated with the sonobuoys could be used for various methods of detecting vessels or enemy vessels. For example, if the sonobuoys were passive sonobuoys, the distance of the vessel from the sonobuoys could be determined from at least three of the sonobuoys in a network. The data could be processed to allow for triangulation of the position of the vessel. The exact position of the sonobuoys can be determined by GPS applications associated with the communicators 140.

The settings of the sonobuoy are programmable. In one embodiment, the settings are selected or chosen before the sonobuoy is deployed. In another embodiment, a set of default settings are used and the attributes, such as the depth of the set of hydrophones can be changed in light of the conditions in which the sonobuoy is deployed. In some embodiments, the communication device can include a microprocessor with sufficient processing power to receive settings and control the apparatus to conform to the received settings. In still further embodiments, the sonobuoy can adapt to the conditions. For example, the microprocessor in the communications device is capable of executing a software instruction set that allows the device to use artificial intelligence to adapt to conditions the sonobuoy encounters. If settings are implemented, in one embodiment, the communication device can provide a user interface that produces prompts to solicit selections from a user.

It should be noted that the communications device is not limited to use on sonobuoys and could be used for other military sensors. For example, a communications device could be placed in an underwater autonomous vehicle (“UAV”). The communications devices could also be used as a land based military sensor. In fact, the communications device could be used in any application where it would be advantageous to have a compact processor with wifi capability. There are also many potential uses encompassing various civilian purposes. The uses are not limited to use as sensors.

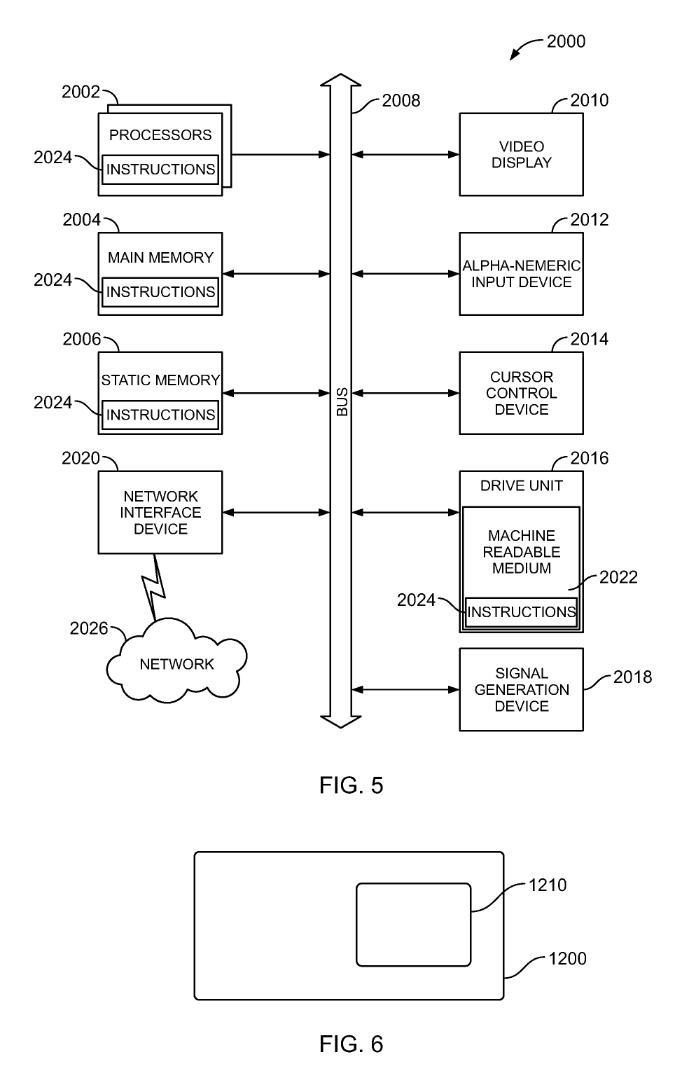

FIG. 5 shows a diagrammatic representation of a computer system 2000, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a portable music player (e.g., a portable hard drive audio device such as a Moving Picture Experts Group Audio Layer 3 (MP3) player, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor or multiple processors 2002 (e.g., a central processing unit (CPU), a graphics processing unit (GPU), arithmetic logic unit or all), and a main memory 2004 and a static memory 2006, which communicate with each other via a bus 2008. The computer system 2000 can further include a video display unit 2010 (e.g., a liquid crystal displays (LCD) or a cathode ray tube (CRT)). The computer system 2000 also includes an alphanumeric input device 2012 (e.g., a keyboard), a cursor control device 2014 (e.g., a mouse), a disk drive unit 2016, a signal generation device 2018 (e.g., a speaker) and a network interface device 2020.

The disk drive unit 2016 includes a computer-readable medium 2022 on which is stored one or more sets of instructions and data structures (e.g., instructions 2024) embodying or utilized by any one or more of the methodologies or functions described herein. The instructions 2024 can also reside, completely or at least partially, within the main memory 2004 and/or within the processors 2002 during execution thereof by the computer system 2000. The main memory 2004 and the processors 2002 also constitute machine-readable media.

The instructions 2024 can further be transmitted or received over a network 2026 via the network interface device 2020 utilizing any one of a number of well-known transfer protocols (e.g., Hyper Text Transfer Protocol (HTTP), CAN, Serial, or Modbus).

While the computer-readable medium 2022 is shown in an example embodiment to be a single medium, the term “computer-readable medium” should be taken to include a single medium or multiple media (e.g., a centralized or distributed database, and/or associated caches and servers) that store the one or more sets of instructions and provide the instructions in a computer readable form. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, tangible forms and signals that can be read or sensed by a computer. Such media can also include, without limitation, hard disks, floppy disks, flash memory cards, digital video disks, random access memory (RAMs), read only memory (ROMs), and the like.

When a computerized method, discussed above, is programmed into a memory of a general purpose computer, the computer and instructions form a special purpose machine. The instructions, when programmed into a memory of a general purpose computer, is in the form of a non transitory set of instructions.

The example embodiments described herein can be implemented in an operating environment comprising computer-executable instructions (e.g., software) installed on a computer, in hardware, or in a combination of software and hardware. Modules as used herein can be hardware or hardware including circuitry to execute instructions. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method(s) can be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

FIG. 6 is a schematic drawing of a machine readable medium 1200 that includes an instruction set 1210, according to an example embodiment. The machine-readable medium 1200 that provides instructions 1210 that, when executed by a machine, cause the machine to perform operations. The instructions 1210 can also use the outputs from the plurality of military sensors, such as the sonobuoys, to track or locate vessels. It should also be pointed out that the above technology may be used for other than military purposes, such as for research and the like.

The present disclosure refers to instructions that are received at a memory system. Instructions can include an operational command, e.g., read, write, erase, refresh, etc., an address at which an operational command should be performed, and the data, if any, associated with a command. The instructions can also include error correction data.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed:

1. A sonobuoy that comprises:
a housing;
a float within the housing;
a communications device within the float; and
a plurality of hydrophones within the housing, the array of hydrophones deployable to an array having known spacings between the hydrophones, the plurality of hydrophones communicatively coupled to the communications device.

2. The sonobuoy of claim 1 wherein the hydrophones are coupled to the communications device via a wire.

3. The sonobuoy of claim 1 wherein the hydrophones are wirelessly coupled to the communications device.

4. The sonobuoy of claim 1 further comprising a frame within the housing to which the plurality of hydrophones are attached.

5. The sonobuoy of claim 1 further comprising a foldable frame within the housing to which the plurality of hydrophones are attached, the foldable frame unfolding when the frame separates from the housing to deploy the plurality of hydrophones.

6. The sonobuoy of claim 1 wherein the communications device is protected against electromagnetic interference.

7. The sonobuoy of claim 1 wherein the communications device is protected against radio frequency interference.

8. The sonobuoy of claim 1 wherein the communications device includes an external input device for selecting a deployment mode for the sonobuoy.

9. The sonobuoy of claim 1 wherein the communications device includes a subscriber identification module for identifying the communications device.

10. The sonobuoy of claim 1 wherein the communications device has a dual band radio frequency output.

11. The sonobuoy of claim 1 wherein the communications device includes a cell phone.

12. The sonobuoy of claim 1 wherein the communications device is capable of being communicatively coupled to a computer network.

13. A network comprising:
a first deployed array of hydrophones communicatively coupled to the network via a first communications device;
a second deployed array of hydrophones communicatively coupled to the network via a second communications device;
a computer communicatively coupled to the first deployed array of hydrophones and the second deployed array of hydrophones, wherein data from the first communications device and the second communications device is shared between the first communication device, the second communication device, and the computer.

14. The network of claim 13 wherein the computer is located on a vessel.

15. The network of claim 14 wherein the vessel is a ship.

16. The network of claim 14 wherein the vessel is an airplane.

17. The network of claim 13 wherein the computer on the network includes an instruction set executable on the microprocessor for locating an object given data from at least one of the first deployed array of hydrophones and the second array of hydrophones.

18. The network of claim 13 wherein at least one of the first communications device and the second communications device includes an associated communications device microprocessor and includes an instruction set executable on the communications device microprocessor for locating an object given data from at least one of the first deployed array of hydrophones and the second array of hydrophones.

19. A method of locating an object comprising:
deploying a first array of hydrophones communicatively coupled to the network via a first communications device;
deploying a second array of hydrophones communicatively coupled to the network via a second communications device;
communicating a first location signal from the first array of hydrophones to the first communications device;
communicating a second location signal from the second array of hydrophones to the second communications device;
networking the first communications device and the second communications device with a computer, wherein data from the first communications device and the second communications device is shared between the first communication device, the second communication device, and the computer.

20. The method of claim 19 wherein the first location signal and the second location signal are input to find the location of an object at the computer.

21. The method of claim 19 wherein the first location signal and the second location signal are input to a microprocessor of at least one of the first communication device or the second communication device to find the location of an object.

22. The sonobuoy of claim 1 wherein software updates can be received and stored by the communications device.

23. The sonobuoy of claim 1 wherein data updates can be received and stored by the communications device.

24. The sonobuoy of claim 1 wherein the hydrophones are part of a transducer that generates acoustic waves.
